(19) United States
(12) Patent Application Publication
(10) Pub. No.: US 2009/0309447 A1
(43) Pub. Date: Dec. 17, 2009

(54) POLYPHASE MACHINE COMPRISING A BELL-SHAPED ROTOR

(75) Inventors: Thomas Leiber, Munchen (DE); Valentin Unterfrauner, Munchen (DE)

Correspondence Address: CONNOLLY BOVE LODGE & HUTZ LLP, 1875 EYE STREET, N.W., SUITE 1100, WASHINGTON, DC, 20006, US

(73) Assignee: IPGATE AG, Zurich (CH)

(21) Appl. No.: 12/517,736

(22) PCT Filed: Dec. 7, 2007
(86) PCT No.: PCT/EP2007/010661

§ 371 Date: Jul. 23, 2009

(30) Foreign Application Priority Data
Dec. 7, 2006 (DE) 10 2006 058 064.8

(51) Int. Cl. H02K 1/30; H02K 21/22

(52) U.S. Cl. 310/156.12; 310/156.26

(57) ABSTRACT

The invention relates to an electrical polyphase machine comprising an inner stator (11) and a rotor (3) that is mounted on a shaft (1). Several permanent magnets (13) are disposed so as to rest against the internal face of a cylindrical rotor (3) wall (3a). The permanent magnets (13), along with at least one electrical field coil (9) of the inner stator, generate an excitation flux which penetrates the cylindrical rotor (3) wall (3a). The rotor (3) is fitted with an entraining element (4) which connects the shaft (1) in a rotationally fixed manner to the cylindrical wall (3a). The cylindrical wall (3a) encompasses the entraining element (4), at least partly rests against the same (4), and is fastened thereto.

The present invention relates to an electrical rotating field machine according to the preamble of Claim 1.

### PRIOR ART

Generic rotating field machines are also referred to as bell rotors. They generally comprise a fixed inner and outer stator and a rotatably supported rotor, with the latter being formed by a bell. Permanent magnet elements for magnetic biasing can be disposed in the bell.

Such a rotating field machine is known from WO2006/000260. However, the rotating field machine described therein is represented in a basic structure. Reference to similar rotating field machines and the prior art is made in the search report of WO2006/000260.

### OBJECT OF THE INVENTION

It is the aim of the invention to derive an assembly structure with which the basic motor structure shown in WO2006/000260 is developed further in such a way that the motor can, on the one hand, be manufactured in a cost-effective manner and facilitates good heat dissipation, while on the other hand constituting a rotor structure with which high mechanical rigidity can be achieved and good concentric running can be accomplished. Here, the motor is supposed to ensure a high efficiency with a low moment of inertia at the same time. Another purpose is to illustrate by which measures the detent torque and thus the concentric running properties can be optimized in such a motor assembly.

This object is inventively achieved by an electric drive comprising the features of Claim 1. Other advantageous developments of this drive become apparent from the features of the dependent claims.

Various developments of the drive according to the invention are explained below with reference to drawings.

In the figures:

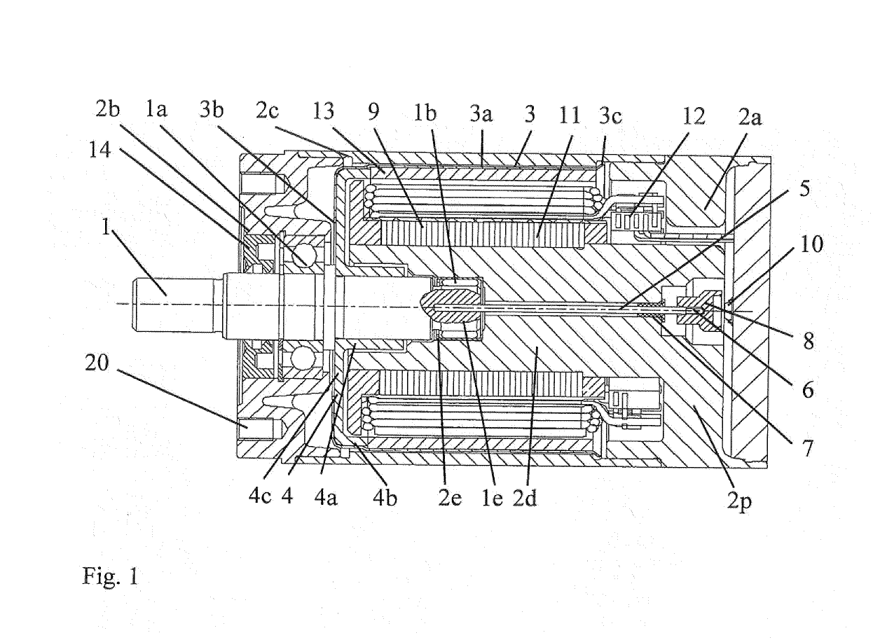

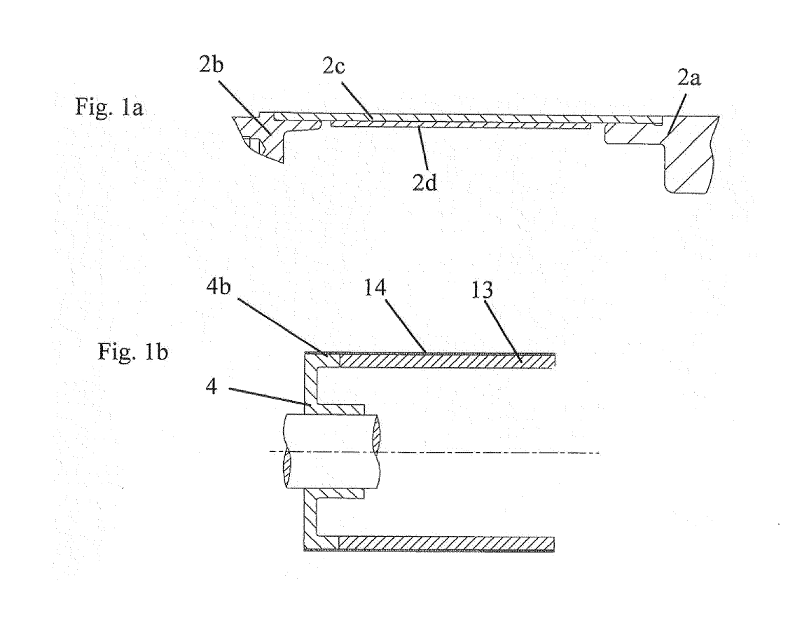

FIG. 1: shows an electric drive according to the invention in a longitudinal section

FIG. 1a: shows an alternative housing assembly

FIG. 1b: shows a variation of the rotor assembly

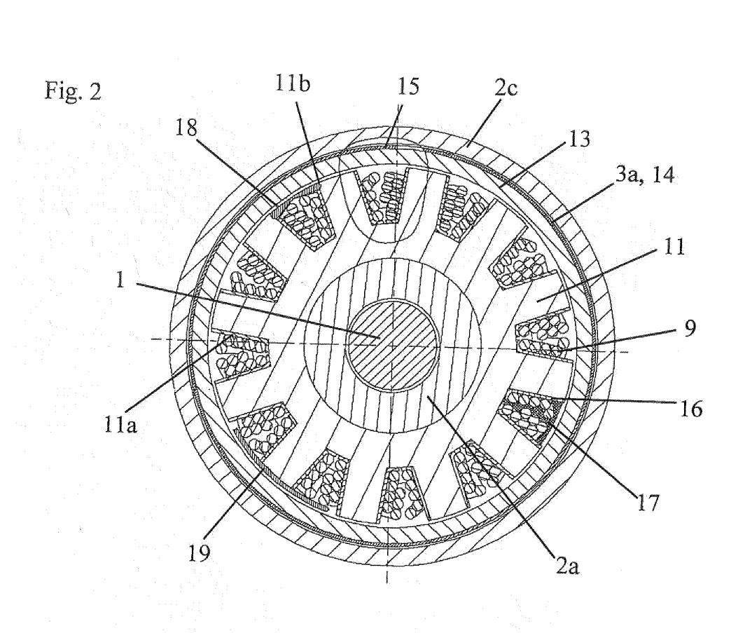

FIG. 2: Shows a cross-sectional view through the stator with the excitation coils.

FIG. 1 shows a longitudinal section through the drive according to the invention. A drive shaft 1, which is rotatably supported with two anti-friction bearings 1a and 1b in the housing of the drive, is provided for transmitting the torque generated in the drive.

The housing comprises three parts. The first frontal housing portion 2a supports the stator 11 and the excitation coifs 9 as well as the bearing 1b and is preferably formed as an aluminum casting. The right frontal housing portion 2b supports the anti-friction bearing 1a of the drive shaft 1 and serves for flange-mounting. Suitable bore holes 20 are provided in the housing portion 2b for this purpose. A third middle housing portion 2c connects the two housing portions 2a and 2b with each other and at the same time forms the return yoke of the magnetic circuit. For this reason, the middle housing portion 2c is formed of ferromagnetic steel.

In order to reduce the eddy current losses, it is also conceivable that an outer stator 2d made of electrical sheet is inserted into the housing portion 2c, as is illustrated in FIG. 1a. This has the advantage that the middle housing portion 2c can be formed of a different material or is manufactured as a simple turned part.

The housing structure enables simple assembly as well as a very compact motor design. By decoupling the magnetic return by means of the double air gap, a very low moment of inertia can be achieved, at the same time achieving a very high moment in the compact construction space. It is therefore particularly advantageous to configure the housing portion 2c forming the magnetic return yoke to be very thin-waited (approx. half the thickness of the width of the groove). Due to this arrangement, it is possible to configure the rotor to have as large a diameter as possible, whereby a large lever arm is provided for generating a large torque.

In contrast to the external rotor motors of the prior art, the return yoke does not rotate and therefore does not constitute a contact protection risk. As a rule, classical external rotor motors comprising a rotating return yoke additionally have to be built into a housing in order to ensure contact protection.

The rotor 3 is formed of two parts. The one part of the rotor 3 is formed by the cylindrical wall 3a, onto which a bottom wall 3b can be formed, so as to form a bell (FIG. 1). Preferably, a collar 3c which protrudes radially outwardly is formed onto the cylindrical wall, the collar being disposed on the side of the cylindrical wall 3a facing away from the bottom wall 3a. The cost-effective manufacture of the bell 3 as a deep-drawn part particularly suggests itself.

The other part of the rotor is formed by the entraining element 4. The bell 3 is preferably connected with the entraining element 4 via a welded joint. Connecting the bell via a welded joint on the bottom wall 3b of the bell 3 with the entraining element 4 is an option that suggests itself in this case.

Preferably, the entraining element 4 is connected with the shaft 1 by means of a press-fit connection. It is of course also possible that the entraining element is non-rotatably sleeved on the shaft in a positive fit. The entraining element 4 is cup-shaped as regards its cross section, or U-shaped as regards its partial cross section, and comprises a first broad-surfaced inner cylindrical wall 4a, with the opening of the U pointing in the direction of the permanent magnets 13.

The entraining element 4 can also be manufactured as a deep-drawn part or casting. This embodiment makes a large surface possible for the press-fit connection with the shaft 1, and makes a space-saving structure possible.

The second cylindrical wall 4b is also directed towards the inside and rests with its outer wall against the inner wall of the cylindrical wall of the rotor bell 3a. High rigidity of the rotor 3 and good concentric running properties are thereby achieved. This is substantially due to the contribution of the configuration of the entraining element 4.

Preferably, the shaft is connected via a resiliency flexible rod 5 with a sensor target 6 pressed into the output shaft 1. The resiliency flexible rod 5 is supported in the housing portion by another bearing 7. This extension suggests itself so that the electronic sensor evaluation system 8 can be attached to the end, directly on the housing, and can thus be directly connected with the electronic system 10.

Alternatively, the shaft 1 can be extended to the sensor target and supported there. However, this leads to an increase of the moment of inertia of the rotor as well as to a reduction of heat transfer capacity of the beam 2a of the stator.

The stator 11 supports the excitation coils 9, which preferably are configured as single coils and are connected with one another by means of a punched grid 12.

The rotor consisting of the bell and the entraining element supports the permanent magnets 13 on the inside of the cylindrical waif 3a of the thin-walled bell. The permanent magnets 13 preferably configured as ring magnets in order for the rotor's inherent rigidity to be increased.

It is additionally advantageous to form the bell of a metallic material so that the required rigidity can be achieved. The selection of a non-ferromagnetic substance as the material suggests itself so that only very small radial forces act on the rotor when the stator is excited. The radial forces are small because no attractive force is exerted on the bell by the stator when it is electrically excited, due to the lack of magnetic properties. The actions of the radial forces of the permanent magnets are balanced because of the double air gap between the excited stator, the rotor and the outer stator. In total very small radial forces result which have an advantageous effect on the concentric running properties of the rotor. This property is very significant in particular in the case of application in control motors. The motor therefore differs significantly from other motors in which the rotor and the magnetic return yoke are formed in one piece and therefore only have a single air gap between the excitation stator and the rotor.

Alternatively, the bell can also be formed of a ferromagnetic material. This improves the electrical properties, because a part of the excitation flux closes over the bell so that the effective magnetic resistance is smaller. Efficiency can thus be improved. However, the stress on the structure increases. Therefore, the material must be selected in accordance with the requirements.

The bearing of the output shaft 1a is sealed by means of a serrated ring and a shaft seal ring 14.

FIG. 1b shows an alternative embodiment of the rotor. The entraining element corresponds to the entraining element shown in FIG. 1. The cylindrical wall 14 fixing or supporting the permanent magnets here is formed as a tube and rests on the outside of the cylindrical wall 4b of the entraining element. This makes a simplified design of the rotor possible, in this case, the tube can be configured as a metallic material, carbon fiber composite material or glass fiber material. The embodiment as carbon fiber particularly makes a significant reduction of the moment of inertia possible, since the tube can be made to be very thin-walled. The connection with the entrainer can be effected by means of a welded joint (metallic material) or by means of an adhesive connection. Because the mechanical strength is slightly less, this rotor structure is suitable in particular for small motors.

FIG. 2 shows a cross section through the stator. The excitation stator 11 with the excitation coils 9 is shown. The magnetic flux 15 is closed over the stator 11 via the permanent magnets 10, the cylindrical wall of the bell 3a/14 and the housing part 2c.

The grooves of the stator have straight flanks 11a and do not comprise pole shoes, as is customary in electro-mechanical engineering. By omitting the pole shoes and choosing straight groove flanks 11a, if is possible to mount single coils on the stator, whereby the copper fill factor can be increased because the coils can be pre-wound with a high geometrical accuracy.

Three variants of fixing the coils are shown in FIG. 2. In a first variation, the groove 11 is insulated by sheets 16. Then, the coils 9 are mounted and molded in with a casting resin 17 to affix them to the stator. The casting resin 17 thus fulfills the function of fixing and also has a heat transfer function.

According to the prior art, the grooves are as a rule provided with pole shoes in order to reduce the detent torque. However, the pole shoes prevent single-tooth winding and require a needle winding technique, whereby only small copper fill factors can be achieved. Higher copper fill factors can be achieved through the configuration of the groove. Using an appropriate favorable pole-groove combination or oblique magnetization of the permanent magnets 13, a very low detent torque can also be achieved with this technique.

In a second variant, the coils are mounted on the stator and fixed in the stator using corresponding wedges 18. in order to attach the wedges, a small recess 11b is provided in the groove flank 11a so that the wedges 18 can be pushed in. It is expedient in a motor fulfilling high requirements with respect to detent torque and true running to form the wedges 18 of a material having magnetic properties, that is, the wedges 18 are either formed of a magnetic plastic or a ferromagnetic steel. The wedges 18 cause the outer contour of the stator to be completely closed, which leads to the magnets being less strongly attracted to the poles. This makes a significant reduction of the detent torque possible. This must be balanced with slightly poorer magnetic properties, because a part of the flux is closed over the wedges and thus does not contribute to the generation of the moments, it is conceivable also in the case of attaching wedges that the coils are molded in together with the stator in order to achieve a better fixation and heat transfer.

This technique can also he used in classical external rotor motors with a single air gap.

As an alternative to the wedges 18, it is also conceivable that a thin-walled ferromagnetic tube 19 is sleeved on or shrunk on the stator. This tube 19 is shown as a section on the bottom left of FIG. 2.

1. An electrical rotating field machine, comprising an inner stator and a rotor attached on a shaft, wherein a plurality of permanent magnets are disposed resting against the inner side of a cylindrical wall of the rotor, and the permanent magnets, together with at least one electrical excitation coil of the inner stator, generates an excitation flux penetrating through the cylindrical wall of the rotor, wherein the rotor comprises an entraining element which connects the shaft non-rotatably with the cylindrical wall, wherein the cylindrical wall encloses the entraining element and at least partially rests against the entraining element and is attached thereto, and that the entraining element is a cup-shaped part comprising a bottom wall and a cylindrical outer wall, wherein the bottom wall has an axial opening for the shaft to extend therethrough, and a collar bordering the opening is disposed on, in particular formed onto, the bottom wall, said collar protruding into the inside of the cup-shaped part and serving for attachment to the shaft, characterized in that the cylindrical wall supporting the permanent magnets is configured to be thin-walled, wherein its wall thickness is smaller, in particular many times smaller, than the wall thickness of the cup-shaped entraining element.

2. The electrical rotating field machine according to claim 1, wherein the cylindrical wall of the rotor, with its inner side, against which the permanent magnets also rest, rests against and/or is attached to the outer side of the cylindrical outer wall of the entraining element.

3. The electrical rotating field machine according to claim 1, wherein a radially inwardly pointing collar is formed onto or attached to the cylindrical wall of the rotor supporting the permanent magnets, said collar being attached to the outer side of the bottom wall of the entraining element, in particular by welding.

4. The electrical rotating field machine according to claim 1, wherein the cylindrical wall supporting the permanent magnets consists of non-ferromagnetic steel.

5. The electrical rotating field machine according to claim 1, wherein the housing of the rotating field machine comprises two frontal housing portions and a middle housing portion disposed therebetween, wherein the one frontal housing portion supports the inner stator and the middle housing portion supports the outer stator and forms the magnetic return yoke, respectively.

6. The electrical rotating field machine according to claim 5, wherein the magnetic return is effected via the middle housing portion formed as a steel tube.

7. The electrical rotating field machine according to claim 5, wherein an electrical sheet package is disposed, in particular received, in the middle housing part.

8. The electrical rotating field machine according to claim 5, wherein the frontal housing portion supporting the inner stator comprises an engagement area extending into the rotor bell, said engagement area adjoining a frontal plate.

9. The electrical rotating field machine according to claim 5, wherein the shaft is supported by means of pivot bearings in both frontal housing portions.

10. The electrical rotating field machine according to claim 8, wherein the shaft is supported, with its one shaft end, in a frontal recess, in particular bore hole, of the engagement area by means of a bearing.

11. The electrical rotating field machine according to claim 8, wherein the one shaft of the shaft is supported within the rotor in the engagement area in a frontal recess, in particular a blind bore or through bore, by means of a bearing, with the bearing and the shaft end being disposed in the area of the permanent magnets of the rotor.

12. The electrical rotating field machine according to claim 11, wherein the shaft portion protruding into the rotor is shorter than the axial extent of the rotor, in particular only half as long as the rotor length or shorter than half the rotor length.

13. The electrical rotating field machine according to claim 1, wherein a target is attached to or integrated in the shaft end of the shaft area extending into the rotor, the movement of said target being determined by a sensor device.

14. The electrical rotating field machine according to claim 13, wherein an in particular resiliently flexible rod bearing the target is disposed on the shaft end of the shaft area extending into the rotor, wherein the rod can be supported in the one frontal housing portion by means of an additional bearing.

15. The electrical rotating field machine according to claim 1, wherein the grooves of the stator have straight flanks.

16. The electrical rotating field machine according to claim 1, wherein the excitation windings are molded into the grooves with casting resin or are enclosed by means of wedges anchored in the groove flanks.

17. The electrical rotating field machine according to claim 1, wherein the grooves of the stator are closed by means of a thin-walled tube, with the tube consisting in particular of a ferromagnetic material.

18. The electrical rotating field machine according to claim 17, wherein the tube is sleeved on and/or shrunk on the stator.

19. The electrical rotating field machine according to claim 1, wherein the permanent magnets are configured as ring magnets.

20. The electrical rotating field machine according to claim 1, wherein the cylindrical wall of the rotor consists of a metallic material, carbon fiber composite material or glass fiber material.
